(19) United States
(12) Patent Application Publication
(10) Pub. No.: US 2014/0248943 A1
(43) Pub. Date: Sep. 4, 2014

(54) PRESENTING SEQUENCED SPONSORED CONTENT WITHIN AN ONLINE GAME

(71) Applicants: Joshua Marc Burgin, Seattle, WA (US); Simon Asselin, Sammamish, WA (US); Diwakar Gupta, Seattle, WA (US)

(72) Inventors: Joshua Marc Burgin, Seattle, WA (US); Simon Asselin, Sammamish, WA (US); Diwakar Gupta, Seattle, WA (US)

(21) Appl. No.: 14/194,657

(22) Filed: Feb. 28, 2014

Related U.S. Application Data
(60) Provisional application No. 61/770,527, filed on Feb. 28, 2013.

(51) Int. Cl. A63F 13/00

(52) U.S. Cl. CPC A63F 13/00
USPC 463/29

(57) ABSTRACT

An online advertising method comprises presenting sequenced or tiered interactive promotional content to a player of a computer-implemented online game. The interactive promotional content comprises a sequence of sponsored interactions with the content for performance by the player, with at least one of the sequence of sponsored activities being a gated activity which is available to the player only if the player has performed a corresponding preceding activity in the sequence.

### FIELD

This disclosure generally relates to online social games and, more specifically, to presenting sponsored content within an online game.

### BACKGROUND

Many online games present advertisements and other promotional content or sponsored content to players of the online games. For example, some online games may display static or dynamic advertisements within the game.

Some sponsored content may be interactive and may be associated with corresponding rewards, so that user interaction with the content is a condition for achieving a corresponding reward. In this way, active player engagement with the sponsored content is promoted, improving exposure of a brand or product promoted in the sponsored content.

### BRIEF DESCRIPTION OF THE DRAWINGS

The example embodiments are illustrated by way of example, and not limitation, in the figures of the accompanying drawings, in which like reference numerals indicate the same or similar elements unless otherwise indicated.

FIG. 1 shows a schematic diagram of a virtual gaming system, according to some example embodiments.

FIG. 2 shows a social network within a social graph, according to some example embodiments.

FIG. 3 is a block diagram illustrating an integrated in-game advertising platform, in some example embodiments.

FIG. 4 is a block diagram illustrating an interface system, in some example embodiments.

FIG. 5 is a flow diagram illustrating a method for presenting interactive promotional content to a player of an online game, in some example embodiments.

FIGS. 6A-6B are flow diagrams illustrating a method for presenting a sequence of sponsored activities to a player of an online game, in some example embodiments.

FIGS. 7A-7C are display diagrams illustrating example displays of sponsored interactive content, in some example embodiments.

FIG. 8 illustrates data flow between example components of the example system of FIG. 1.

FIG. 9 illustrates an example network environment in which various embodiments may operate.

FIG. 10 illustrates an example computing system architecture, which may be used to implement one or more of the methodologies described herein.

FIGS. 11A-11E depict an example embodiment of a promotional content presented on a user device to prompt performance of a linked sequence of player interactions with the content, the content comprising a linked sequence of prompts for respective interactions with the promotional content (also referred to herein as sponsored activities).

### DESCRIPTION OF EXAMPLE EMBODIMENTS

### Overview

Example embodiments described below disclose a method and system to present sequenced or tiered interactive promotional content to a player of a computer-implemented online game. The interactive promotional content may comprise a sequence of sponsored activities for performance by the player, with at least one of the sequence of sponsored activities being a gated activity which is available to the player only if the player has performed a corresponding preceding activity in the sequence.

The sequence of sponsored activities may be presented as a substantially uninterrupted linked series of activities, with the performance of each activity making available a successive activity in the series. Progression along the sequence of sponsored activities may be subject to player input, so that the player has the option of performing all of the sponsored activities in the sequence, or of performing only a subset of the sequence.

The method may include determining a level of interaction of the player with the interactive promotional content, for example by determining the number of sponsored activities in the sequence performed by the player, e.g. by quantifying the player-selected subset of activities. The method may further include providing a benefit to the player based at least in part on the determined level of interaction, for example based at least in part on the number of activities in the sequence which the user actually performed.

The sequence of sponsored activities may be presented to the user response to occurrence of a trigger event in the computer-implemented game, for example comprising a friction point in a game fiction. In such a case, the method may include presenting to the user a plurality of alternative options for resolving the friction point, with one of the plurality of options being presentation of the sequence of sponsored activities. For example, in certain games, players may run out of energy before a game concludes. Within these games, the systems and methods described herein may present a dialog box to the player that indicates an option to watch an advertisement in order to receive additional energy and continue playing the game. Once the player views the advertisement, the game provides supplemental energy to the player. In other embodiments, a friction point in the game fiction may comprise a challenge to be overcome by a player, e.g., defeating a boss character or the like.

The sequence of sponsored activities may comprise a plurality of different types of activities, for example including two or more of an advertisement, video content, a survey related to a brand or product, an interactive mini-game, or the like. In some embodiments, the sequence of sponsored activities include a video activity in which video content related a brand or product is displayed on the user device, and a subsequent interactive survey about the video content.

In some embodiments, the benefit for player interaction with the interactive promotional content comprises a separate reward for each of the sponsored activities in the sequence. In such cases, the rewards may, in general, progressively increase in value with progression along the sequence.

These and other example embodiments are described, by way of example, in further detail below.

### Example Systems

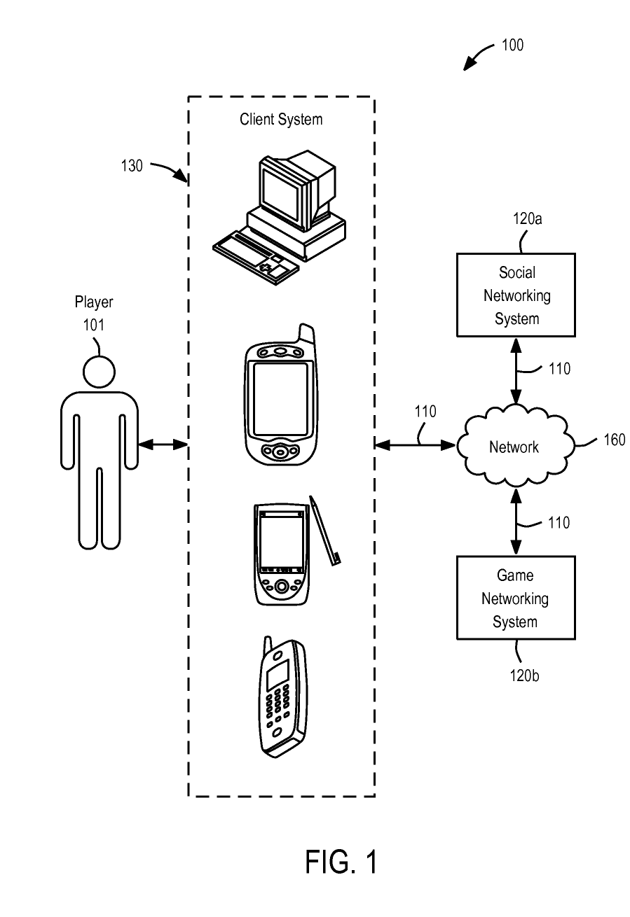

FIG. 1 illustrates an example of a system 100 for implementing various disclosed embodiments. In particular embodiments, the system 100 comprises a player 101, a social networking system 120a, a game networking system 120b, a client system 130, and a network 160. The components of the system 100 may be connected to each other in any suitable configuration, using any suitable type of connection. The components may be connected directly or over a network 160, which may be any suitable network. For example, one or more portions of the network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

The social networking system 120a may be a network-addressable computing system that can host one or more social graphs. The social networking system 120a may generate, store, receive, and transmit social networking data. The social networking system 120a may be accessed by the other components of the system 100 either directly or via the network 160. The game networking system 120b is a network-addressable computing system that may host one or more online games. The game networking system 120b may generate, store, receive, and transmit game-related data, such as, for example, game account data, game input, game state data, and game displays. The game networking system 120b may be accessed by the other components of the system 100 either directly or via network 160. The player 101 may use the client system 130 to access, send data to, and receive data from the social networking system 120a and the game networking system 120b. The client system 130 may access the social networking system 120a or the game networking system 120b directly, via the network 160, or via a third-party system. For example, the client system 130 may access the game networking system 120b via the social networking system 120a. The client system 130 may be any suitable computing device, such as a personal computer, laptop, cellular phone, smart phone, computing tablet, and so on.

The components of the system 100 may be connected to each other using any suitable connections 110. For example, the suitable connections 110 may include wireline (e.g., Digital Subscriber Line (DSL) or Data Over Cable Service Interface Specification (DOCSIS)), wireless (e.g., Wi-Fi or Worldwide Interoperability for Microwave Access (WiMAX)) or optical (e.g., Synchronous Optical Network (SONET) or Synchronous Digital Hierarchy (SDH)) connections. One or more connections 110 may include an ad hoc network, an intranet, an extranet, a VPN, a LAN, a WLAN, a WAN, a WWAN, a MAN, a portion of the Internet, a portion of the PSTN, a cellular telephone network, another type of connection, or a combination of two or more such connections. The connections 110 need not necessarily be the same throughout the system 100. One or more first connections 110 may differ in one or more respects from one or more second connections 110.

In an online computer game, a game engine manages a game state of the game. The game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs), and in-game objects. The game engine also manages game state, including player character state for currently active (online) and inactive (offline) players.

An online game may be hosted by the game networking system 120b, which can be accessed using any suitable connection 110 with a suitable client system 130. A player 101 may have a game account on the game networking system 120b, wherein the game account can contain a variety of information associated with the player 101 (e.g., the player's personal information, financial information, purchase history, player character state, game state). In some example embodiments, the player 101 may play multiple games on the game networking system 120b, which may maintain a single game account for the player 101 with respect to all the games, or multiple individual game accounts for each game with respect to the player 101. In some example embodiments, the game networking system 120b may assign a unique identifier to each player 101 of an online game hosted on the game networking system 120b. The game networking system 120b may determine that a player 101 is accessing the online game by reading the user's cookies, which may be appended to HTTP requests transmitted by the client system 130, and/or by the player 101 logging onto the online game.

In some example embodiments, the player 101 may access an online game and control the game's progress via the client system 130 (e.g., by inputting commands to the game at the client device). The client system 130 may display the game interface, receive inputs from the player 101, transmit user inputs or other events to the game engine, and receive instructions from the game engine. The game engine can be executed on any suitable system (e.g., the client system 130, the social networking system 120a, and/or the game networking system 120b). For example, the client system 130 may download client components of an online game, which are executed locally, while a remote game server, such as the game networking system 120b, provides backend support for the client components and may be responsible for maintaining application data of the game, processing the inputs from the player 101, updating and/or synchronizing the game state based on the game logic and each input from the player 101, and transmitting instructions to the client system 130. As another example, each time the player 101 provides an input to the game through the client system 130 (e.g., by typing on the keyboard or clicking the mouse of client system 130), the client components of the game may transmit the player's input to the game networking system 120b.

In an online multiplayer game, players may control player characters (PCs), a game engine controls non-player characters (NPCs) and game features, and the game engine also manages player character state and game state and tracks the state for currently active (i.e., online) players and currently inactive (i.e., offline) players. A player character can have a set of attributes and a set of friends associated with the player character. As used herein, a term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), and so forth. The game engine may use the player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player 101.

In some example embodiments, the player 101 may access particular game instances of an online game. A game instance is a copy of a specific game play area that is created during runtime. In some example embodiments, a game instance is a discrete game play area where one or more players 101 may interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In some example embodiments, a game instance is populated by one or more player characters controlled by one or more players 101 and one or more in-game objects controlled by the game engine. When accessing an online game, the game engine may allow the player 101 to select a particular game instance to play from a plurality of game instances. Alternatively, the game engine may automatically select the game instance that the player 101 will access. In some example embodiments, an online game comprises only one game instance that all players 101 of the online game can access.

In some example embodiments, a specific game instance may be associated with one or more specific players 101. A game instance is associated with a specific player 101 when one or more game parameters of the game instance are associated with the specific player 101. For example, a game instance associated with a first player 101 may be named “First Player's Play Area.” This game instance may be populated with the first player's PC and one or more in-game objects associated with the first player 101. In some example embodiments, a game instance associated with a specific player 101 may only be accessible by that specific player 101. For example, a first player 101 may access a first game instance when playing an online game, and this first game instance may be inaccessible to all other players 101. In other embodiments, a game instance associated with a specific player 101 may be accessible by one or more other players, either synchronously or asynchronously with the specific player's game play. For example, a first player 101 may be associated with a first game instance, but the first game instance may be accessed by all first-degree friends in the first player's social network. In some example embodiments, the game engine may create a specific game instance for a specific player 101 when that player 101 accesses the game. For example, the game engine may create a first game instance when a first player 101 initially accesses an online game, and that same game instance may be loaded each time the first player 101 accesses the game. For example, the game engine may create a new game instance each time a first player 101 accesses an online game, wherein each game instance may be created randomly or selected from a set of predetermined game instances. In some example embodiments, the set of in-game actions available to a specific player 101 may be different in a game instance that is associated with that player 101 compared to a game instance that is not associated with that player 101. The set of in-game actions available to a specific player in a game instance associated with that player 101 may be a subset, superset, or independent of the set of in-game actions available to that player 101 in a game instance that is not associated with him. For example, a first player 101 may be associated with Blackacre Farm in an online farming game. The first player 101 may be able to plant crops on Blackacre Farm. If the first player 101 accesses a game instance associated with another player 101, such as Whiteacre Farm, the game engine may not allow the first player 101 to plant crops in that game instance. However, other in-game actions may be available to the first player 101, such as watering or fertilizing crops on Whiteacre Farm.

In some example embodiments, a game engine can interface with a social graph. Social graphs are models of connections between entities (e.g., individuals, users, contacts, friends, players, player characters, non-player characters, businesses, groups, associations, concepts, and the like). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some example embodiments, a unique client identifier can be assigned to each user in the social graph. This disclosure assumes that at least one entity of a social graph is a player or player character in an online multiplayer game, though this disclosure includes any suitable social graph users.

The minimum number of edges required to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within N. degrees of the player, where Nₘₐₓ is the maximum degree of separation allowed by the system managing the social graph (e.g., the social networking system 120a or the game networking system 120b). In some example embodiments, Nₘₐₓ equals 1, such that the player's social network includes only first-degree friends. In some example embodiments, Nₘₐₓ is unlimited and the player's social network is coextensive with the social graph.

In some example embodiments, the social graph is managed by the game networking system 120b, which is managed by the game operator. In other embodiments, the social graph is part of a social networking system 120a managed by a third-party (e.g., Facebook®, Friendster, Myspace). In other embodiments, the player 101 has a social network on both the game networking system 120b and the social networking system 120a, wherein the player 101 can have a social network on the game networking system 120b that is a subset, superset, or independent of the player's social network on the social networking system 120a. In such combined systems, the game network system 120b may maintain social graph information with edge type attributes that indicate whether a given friend is an “in-game friend,” an “out-of-game friend,” or both. The various embodiments disclosed herein are operable when the social graph is managed by social networking system 120a, game networking system 120b, or both.

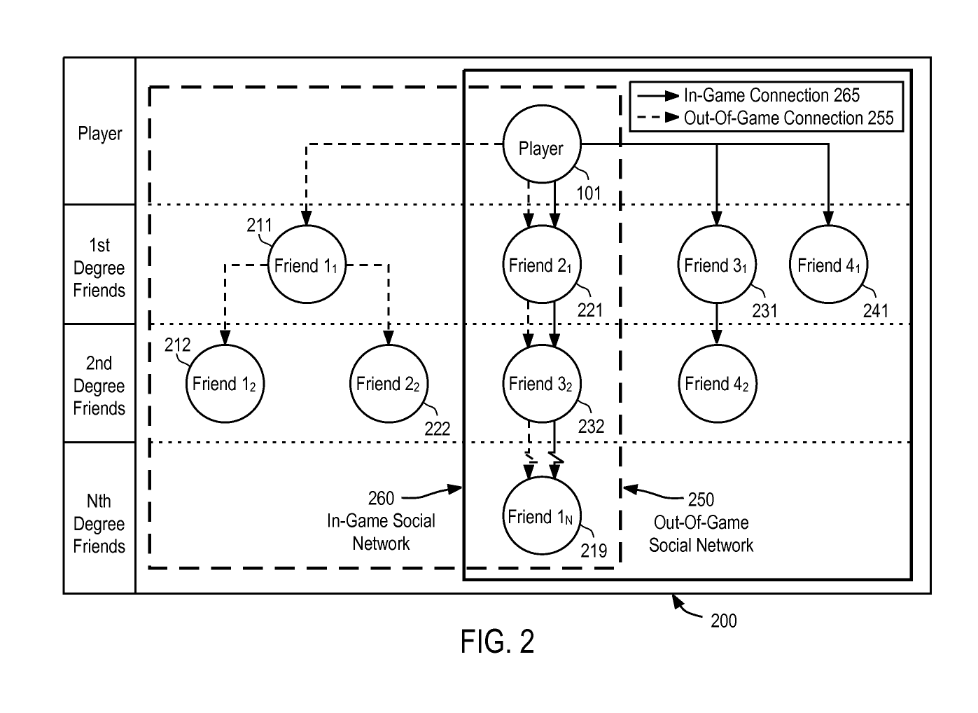

FIG. 2 shows an example of a social network 200 within a social graph. As shown, Player 201 can be associated, connected, or linked to various other users, or “friends,” within the social network 250. These associations, connections or links can track relationships between users within the social network 250 and are commonly referred to as online “friends” or “friendships” between users. Each friend or friendship in a particular user's social network within a social graph is commonly referred to as a “node.” For purposes of illustration and not by way of limitation, the details of the social network 250 will be described in relation to Player 201. As used herein, the terms “player” and “user” can be used interchangeably and can refer to any user or character in an online multiuser game system or social networking system. As used herein, the term “friend” can mean any node within a player's social network.

As shown in FIG. 2, Player 201 has direct connections with several friends. When Player 201 has a direct connection with another individual, the connection is referred to as a first-degree friend. In the social network 250, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211. The limit on the depth of friend connections, or the number of degrees of separation for associations, that Player 201 is allowed is typically dictated by the restrictions and policies implemented by social networking system 120a.

In some example embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may take advantage of and utilize the distinction between the various degrees of friendship relative to Player 201.

In some example embodiments, a player (or player character) may have a social graph within an online multiplayer game that is maintained by the game engine and another social graph maintained by a separate social networking system. FIG. 2 depicts an example of an in-game social network 260 and the out-of-game social network 250. As discussed herein, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. That is, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. For example, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 may have second-degree and higher-degree friends in both his in-game and out of game social networks. In some embodiments, it is possible for Player 201 to have a friend connected to him both in his in-game and out-of-game social networks, wherein the friend is at different degrees of separation in each network. For example, if Friend 2₂ 222 had a direct in-game connection with Player 201, Friend 2₂ 222 would be a second-degree friend in Player 201's out-of-game social network, but a first-degree friend in Player 201's in-game social network. In particular embodiments, a game engine can access the in-game social network 260, the out-of-game social network 250, or both.

In some example embodiments, the connections in a player's in-game social network can be formed both explicitly (e.g., users should “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

### Example of Integrated In-Game Advertisement Platform

In some example embodiments, the systems and methods described herein provide an integrated interface to different advertisement providers, in order to provide a single player experience/interaction between users/players of online games and the presented advertisements, among other benefits. The systems and methods may present advertisements and other sponsored content or promotional material in various formats, such as JPEG, video, HTML5, and so on. For example, different media inputs are converted to a single user interface (UI) to provide a uniform, transparent experience to the player. That is, the entire player experience, from load to completion (and any interaction with the media, such as rewards), may take place within the single UI, among other things.

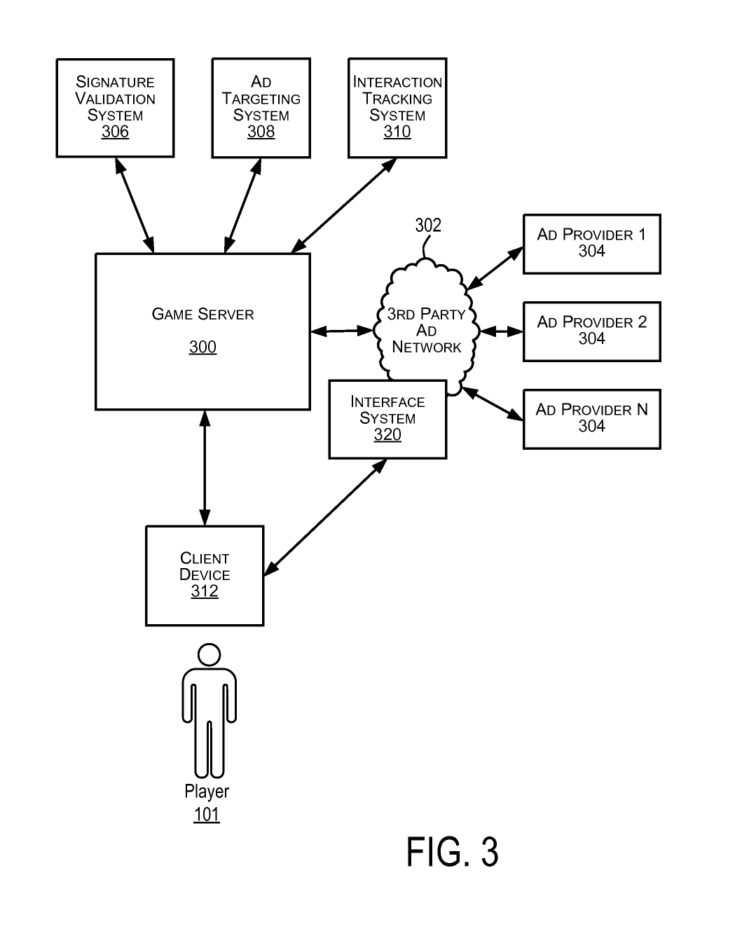

FIG. 3 is a block diagram illustrating an integrated in-game advertising platform, in some example embodiments. The platform may include a game server 300 that communicates with a third party advertisement network 302 that is configured to provide advertisements or other sponsored content from various sponsored content providers 304 (e.g., Ad Provider 1, Ad Provider 2, Ad Provider N), such as game sponsors and other sponsoring entities. The game server 300 and/or the advertisement network 302 may provide advertisements and other sponsored content to the client device 312, such as within or overlaying a game fiction of an online game provided by the game server 300.

The game server 300 may also communicate with various systems that perform methods associated with presenting advertisements and other sponsored content to players via their client devices 312, such as a signature validation system 306 configured to validate devices within the platform, an ad targeting system 308 configured to identify, target, and/or match advertisements to players viewing the advertisement, and/or an interaction tracking system 310 configured to track interactions between players via a client device 312 and interactions with presented advertisements.

The following is an example of different components that may interact between the game server 300 and the interface system 320 associated with the third party advertisement network 302 in order to present sequences of sponsored activities to players 101, for example to resolve friction points within online games based on the presentation of interactive advertisements. Note that many architectures alternative to that described below fall within the scope of this disclosure. Features of the interface system 320 may, for example, be integrated in the game server 300. Alternatively, the functions of the various processing components of FIG. 3 may be performed by distributed processing devices.

Once an online game is launched, the game server 300 initializes Flash based on an initUser transaction. The game server 300 fetches targeting information from a targeting service, such as the ad targeting system 308. At the same time or in parallel, the game server 300 initializes the online game code (e.g., game html or JavaScript), by (1) fetching 3PAN playloads from a ZRuntime script, and (2) outputting an appropriate 3PAN payload into a page stream to create a 3PAN JavaScript module which can retrieve interactive content from the third party advertisement network 302. At a friction point, the game server 300, via Flash, identifies available content. If available, the game server 300 presents an option to view the content, and when the player selects the option, the 3PAN payload calls a load function with a pointer to the div/frame that is rendering the retrieved content. Upon completion of a presentation of the content, the 3PAN payload transmits a “completed message” to the game server 300, and closes the content window. The game server 300 then resolves the friction point by granting energy or performing other transactions within the online game.

In some example embodiments, displayed sponsored content may be in a rich-media format, and include a video piece along with a survey or quiz questions, although in some cases, the advertisements may include arbitrary web content (pure video, display only, rich media, and so on). In some example embodiments, the game server 300 may utilize an IFrame window triggered from a Flash or HTML5 game client as the content placement mechanism.

In some example embodiments, the interface system 320 may provide an SDK that reduces in-game integration costs, among other things. The SDK may also provide uniform tracking and allow the interface system 320 to manage and onboard new advertisement networks and/or content providers without game studio development involvement. The system may also integrate with a targeting engine, such as ad targeting system 308, providing the ability to target the promotional content of respective sponsored activities in a sequence of activities themselves, as well as target in-game placements to different player segments based on their geography, demographics, behavior, and so on.

As described herein, in some example embodiments, the third party advertisement network 302 may provide a single and/or integrated interface, such as an interface system 320, that includes components that perform various methods for presenting advertisements and other sponsored content to players of an online game, such as to resolve friction points within a game fiction or dialog, among other things.

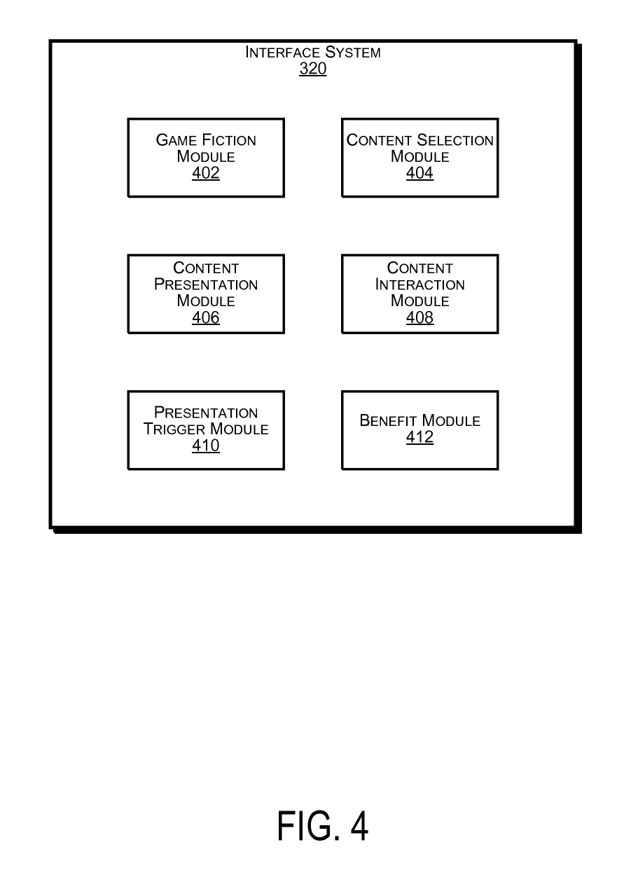

FIG. 4 is a block diagram illustrating the interface system 320, in some example embodiments. The interface system 320 may include various hardware and/or software modules, such as a game fiction module 402, a content selection module 404, a content presentation module 406, a content interaction module 408, a presentation trigger module 410, and a benefit module 412.

In some example embodiments, the game fiction module 402 is configured and/or programmed to receive an indication of an occurrence of a trigger event within a game fiction of an online game. For example, the game fiction module 402 may receive from the game server 300 an indication that a player of an online game has arrived at a friction point or pinch point within a game fiction, such as an occurrence of a player running out of energy, having a low or empty account of virtual currency, failing a task or quest within the online game, and so on. In some embodiments, the trigger event may comprise user selection of an option associated with presentation of interactive promotional content comprising a sequence of sponsored activities. In such case, the presentation trigger module 410 may be configured to present a plurality of alternative options to the player in response to, for example, a friction point in the game fiction, one of the alternative options being associated with presentation of the interactive promotional content.

In some example embodiments, the game content selection module 404 is configured and/or programmed to select interactive sponsored content from a group of content providers, to be presented to the player of the online game. For example, the content selection module 404 may select interactive content (e.g., an interactive advertisement such as a video, quiz, and so on) from the Ad Providers 304, based on information received from the game server 300, such as information from the ad targeting system 308 that provides information associated with characteristics of a player playing the online game, a state of the online game, and so on.

In some example embodiments, the content presentation module 406 is configured and/or programmed to directly (or, indirectly via the game server) present the interactive content to a user device associated with a player of an online game. For example, the content presentation module 406 directly presents the interactive content to the client device 312 by overlaying the content over an online game provided by the game server 300 that is currently running on the client device 312.

In some example embodiments, the content interaction module 408 is configured and/or programmed to determine that the player of the online game has interacted with the presented interactive content. For example, the content interaction module 408 may determine that a video has played, a player has answered one or more questions from a displayed interactive quiz, may receive an indication from the game server 300 that the player has viewed the content, and so on.

Once it has been determined that the player has interacted with the presented interactive content, the game fiction module 402 may transmit to the game server 300 an indication that the player has interacted with the presented interactive content, and the benefit module 412 may provide a benefit to the player 101 based on player interaction with the presented promotional content. In some embodiments, the benefit may comprise resolution of the friction point in the game fiction.

Presenting Sequenced Sponsored Content to Players of an Online Game

As described herein, in some example embodiments, the systems and methods present sponsored content as tiers or chains of content within an online game. The systems and methods may present a sequence of interactive, reward-based, advertisements (e.g., video, quizzes, surveys, and so on), and in response to determining a level of interaction between a player and a sequence of content, provide the player with various incentives and/or rewards, such as those described herein.

For example, when a player arrives at a friction point within a game fiction, the systems and methods may present the player with a variety of options that enable the player to resolve the friction point, including an option associated with a tiered or sequenced group of interactions between the player and sponsored content. The player may select the option associated with interacting with tiered content, and, depending on the player's level of interaction with presented content, the systems may provide the player with rewards (e.g., energy, virtual currency, and so on), which enable the player to resolve the friction point and continue playing an online game within the current game fiction, among other things.

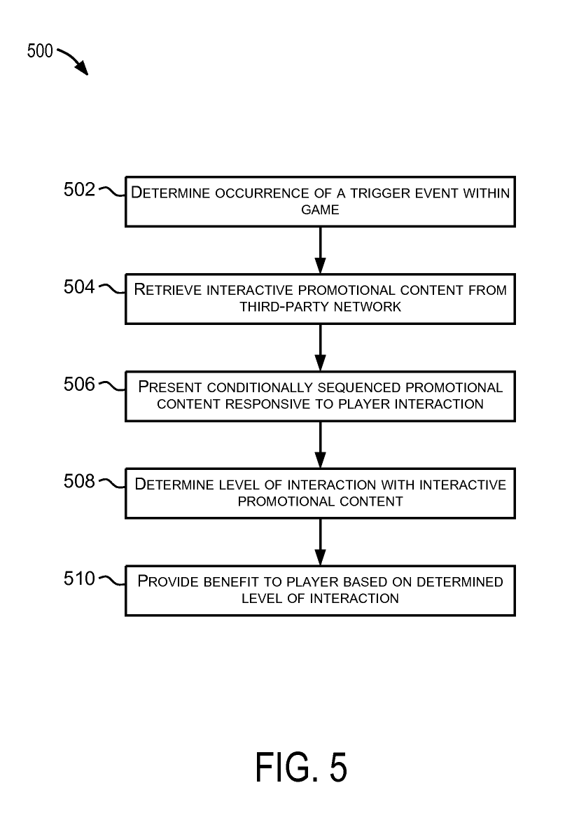

FIG. 5 is a flow diagram illustrating an example embodiment of a method 500 for presenting sponsored content to a player of an online game. In operation 502, the interface system 320 determines the occurrence of a trigger event within the game. In this example embodiment, the trigger event is a friction point or pinch point within a game fiction. For example, the game fiction module 402 may receive an indication from the game server 300 that a player has reached a friction point or pinch point within a game fiction.

Example friction points may include running low or out of energy, running low or out of virtual currency, running low or out of time to complete a task or project within the game, failing to complete a task or project within the game, losing a competition within the online game, and so on. In other embodiments, friction points within the game fiction may comprised progression of a player to a particular point within the game fiction, regardless of performance of the player with respect to that point in the game fiction. In some case, for example, a particular in-game challenge or impasse came be overcome only by user interaction with the interactive sponsored content, as described below, so that arrival of the player at the predetermined point in the game fiction constitutes a trigger event that causes presentation of interactive promotional content. Trigger events can instead, or in addition, comprise user selection of an option to interact with promotional content for associated benefits.

In operation 504, the interface system 320 retrieves interactive promotional content from a third party network of advertisement providers, the interactive promotional content comprising a sequence of sponsored activities for performance by the player. “Promotional” means content or activities that promote an associated brand, product, or service. “Sponsored” means content or activities provided to players via the game at a cost to an entity (e.g., an advertiser) associated with the promoted brand, product, or service.

For example, the content selection module 404 selects and retrieves a plurality of sponsored activities (e.g., a video advertisement and an interactive quiz) from one of multiple content providers associated with the third party advertisement network 302. In this example embodiment, the plurality of sponsored activities retrieved for presentation in a linked sequence are with respect to a common promotional subject (e.g., being with respect to a particular product). Thus, for example, the interactive promotional content may comprise a sequence of sponsored activities consisting of a trailer for a new movie, a survey or questionnaire about the new movie, and a minigame that relates to the new movie and that can be played by the player.

In operation 506, the interface system 320 presents the retrieved interactive content directly to a computing device associated with a player of the online game. For example, the content presentation module 406 overlays a presentation of a retrieved advertisement on top of a currently running game within the client device 312. Presentation of the promotional content, at operation 506, may consist of conditionally sequenced presentation. Thus, the sponsored activities of the sequence may be presented one at time, with presentation of successive activities being conditional upon player performance of a preceding activity.

Considering the above-mentioned example of interactive emotional content for a new movie, the conditionally sequenced presentation of the sequence of activities may comprise presenting the player with the option of watching the video advertisement consisting of the movie trailer. Upon completion of the movie trailer replay, a message may be displayed informing the player of achieved benefits. For example, the player may be advised that a certain number of in-game power-ups (say, three) have been achieved.

After completion of replay of the movie trailer, the player may be presented with a choice between answering the associated survey, or returning to the game. A benefit associated with answering the survey may be displayed on the client device 312 together with the options. In this example, in-game benefits associated with the respective activities of the promotional sequence progressively increase in value. For example, the player may be informed that completion of the survey would be rewarded by an increased number of power-ups relative to that for watching the movie trailer (say, five). Note that, in this example, the sponsored survey is a gated activity in that it is available to the player only if the player has performed the preceding activity, in this case having watched the trailer. In response to selecting to answer the survey, the survey is presented to the player and the associate benefit accrues to the player.

After completion of the survey, the player is in this example embodiment presented with yet another choice. In this example, the player can choose between playing the sponsored minigame related to the new movie, or returning to the underlying persistent game. The minigame is again a gated activity available on the condition that the player has completed the linked survey. An associated benefit may again be advertised, to incentivize further player interaction. The associated benefit may again be greater in value than the benefit for the preceding activity, in this example being, say, seven power-ups. In response to selecting to participate in the minigame, the sponsored minigame is presented to the player, after which the associated benefit accrues to the player and action returns to the on-going game fiction in the persistent game. Note that the sequence of activities in the above example is presented as a substantially uninterrupted linked series of activities, without any gameplay of the underlying persistent game between neighboring activities.

In operation 508, the interface system 320 determines a level of interaction of the player with the sequentially presented interactive promotional content. Determining the level of interaction may comprise determining the number of activities in the sequence of sponsored activities performed by the user. Note that conditionally sequenced presentation of a plurality of activities, as described above allows the player, at his preference, to perform all of the activities in the sequence or to perform only a subset of the sponsored activities. Determining the level of interaction may in such cases comprise quantifying the performed subset of activities. If, for example, the player performs all three of the above-described activities in the example sequence for promoting a new movie, the subset may be quantified as comprising three activities. If, however, the player opts to return to the game after watching the trailer, the number of performed activities would be determined to be one activity. Should the player opt to exit the linked sequence after answering the survey, the number of activities in the performed subset will be determined as equaling two activities.

In some embodiments, the level of interaction is determined only by the number of activities that the player performs. Instead, or in addition, one or more scores or other performance metrics achieved by the player in at least some of the performed activities may also be taken into account in determining the level of interaction, so that the value of benefits earned by the player is determined, at least in part, by the quality of the player's performance within the sponsored activities. A score indicative of how many questions in the questionnaire are answered correctly, and/or score achieved by the player in the minigame may, for example, be factored into determination of the player's level of interaction with the interactive promotional content. For example, the content interaction module 408 determines that playback of the advertisement was completed at the client device 312, that the player selected to participate in the subsequent survey, and may determine the player's score in the survey.

In operation 510, an benefit is provided to the player based on the determined level of interaction with the interactive promotional content. The value of the benefit may be dependent on the determined level of interaction. The value of the achieved benefit may thus be greater for greater levels of interaction. The benefit awarded to the player for interaction with the interactive promotional content may be in-game benefits, for example comprising in-game resources, objects, abilities, currency, or the like. In some examples, the benefit may comprise resolution of an associated friction point in the game fiction. For example, the game server 300 may resolve a friction point by awarding a player energy or virtual currency, by assisting a player with a quest, and so on. In other embodiments, the benefits may include out-of-game benefits, comprising, for example, promotional offers, coupons, discounts, or the like.

Of course, in some example embodiments, the interface system 320 and/or the game server 300 may perform method 600 at various other times within a game fiction, such as other points within a game fiction that may require a player to perform a task or other action with an online game, at times when a player's status or associated metrics indicate a possible need for a reward (e.g., the player is running low on energy), or the like

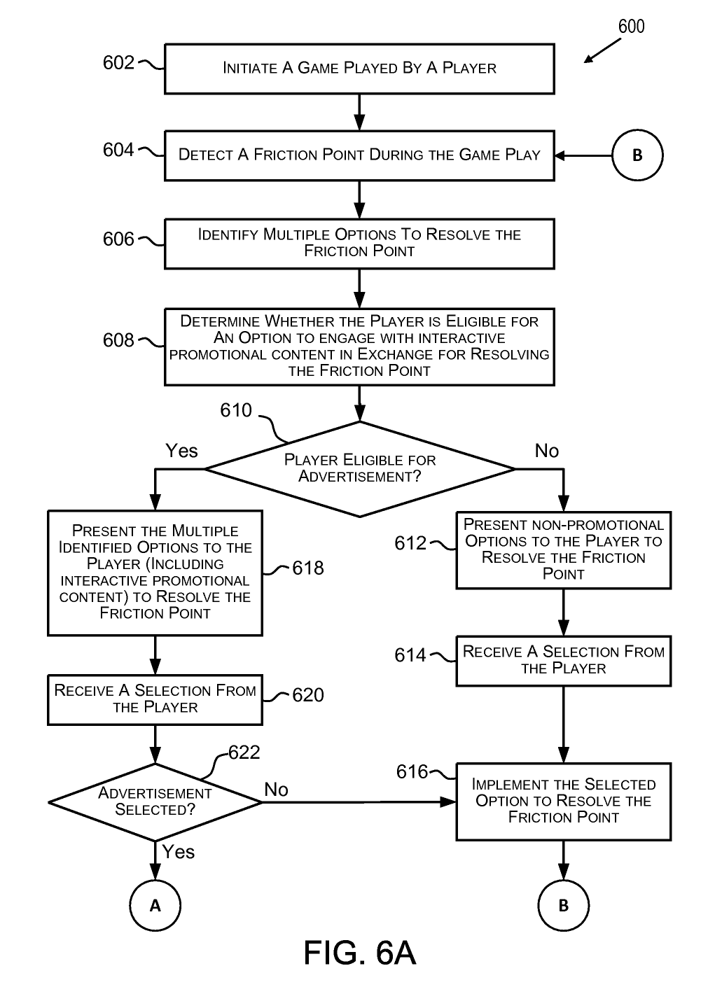

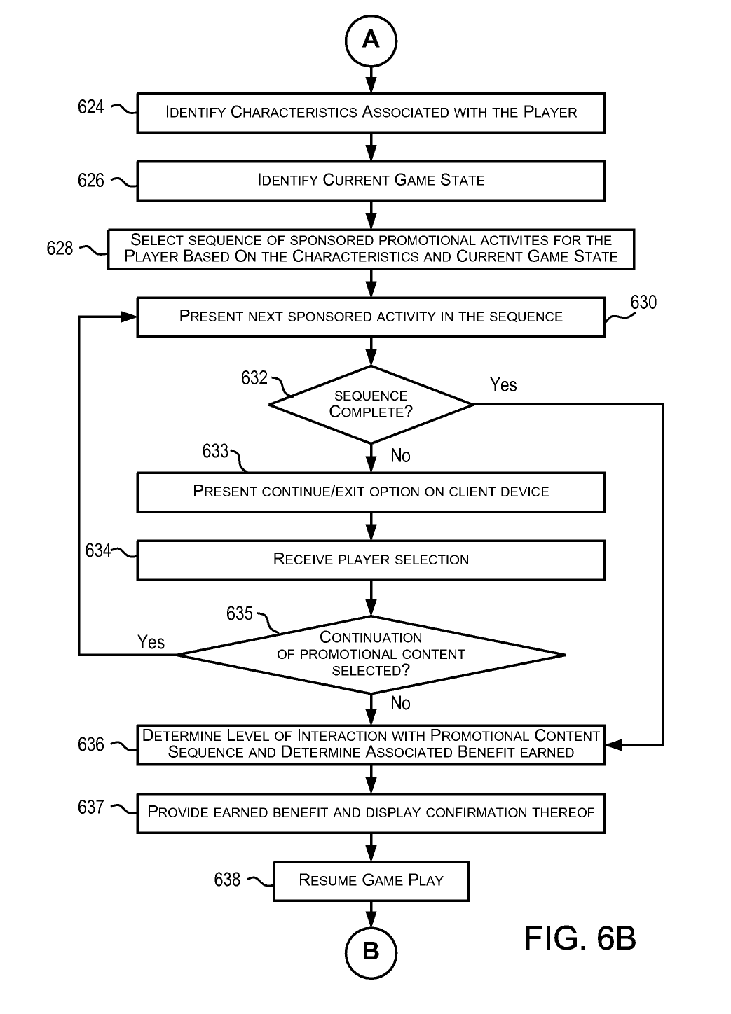

FIGS. 6A-6B are flow diagrams illustrating a more detailed example embodiment of a method performed by the game server 300 and/or the interface system 320, in some example embodiments. In operation 602, the game server 300 initiates a game played by a player. In operation 604, the game server 300 detects a friction point during game play. In operation 606, the game server 300 identifies multiple options to resolve the friction point. In operation 608, the game server 300 determines whether the player is eligible for an option to engage with interactive promotional content in exchange for resolving the friction point.

If it is determined, at operation 610, that the player is not eligible for the interactive promotional content, non-promotional options are presented, at operation 612, for resolving the friction point. In operation 614, the game server 300 receives a selection from the player, and, via operation 616, implements the selected non-promotional option to resolve the friction point.

If it is determined, at operation 610, that the player is eligible for being presented with the interactive promotional content, interface system 320, at operation 618, presents the multiple identified options to the player to resolve the friction point, with one of the options being to view/interact with promotional content or advertisement content. In operation 620, a selection is received from the player. In operation 622, when the interactive promotional content is selected, the interface system 320 identifies, via operation 624 of FIG. 6B, characteristics associated with the player. In operation 626, the interface system 320 identifies a current game state. In operation 628, the interface system 320 selects particular targeted interactive promotional content for the player based on the characteristics and on the current game state.

In operation 630, the selected interactive promotional content is presented to the player. In a first iteration of operation 630, and initial or first sponsored activity in the sequence of sponsored activities of the interactive promotional content is presented to the player (for example comprising the movie trailer in the example embodiment described with reference to FIG. 5). In each successive iteration of operation 630, a successive sponsored activity in the sequence of sponsored activities is presented.

After completion of each of the activities in the sequence, it is determined, at operation 632, whether the sequence is complete, or whether there are remaining sponsored activities in the sequence. If there are further activities in the sequence, options are presented on a game user interface, at operation 633, for the player to continue interaction with the interactive promotional content, or to return to the game. After receiving the relevant user input, at operation 634, the next sponsored activity in the sequence is presented to the player, at operation 630, if it is determined, at operation 635, that the player chose to continue. If not, a level of interaction with the interactive promotional content is determined, at operation 636, as described earlier. The same applies in response to determining, at operation 632, that the sequence is complete.

Thereafter, the particular benefit earned by the determined level of interaction is calculated, at operation 636, and is credited to the player, at operation 637, together with displaying a confirmation thereof on the game user interface. As mentioned, the benefit can comprise resolution of an originally identified friction point, in-game assets, and/or out-of-game benefits. iThereafter, gameplay is resumed, at operation 638.

Thus, in some example embodiments, the game server 300 and various modules of the game server 300 may perform various methods for resolving friction points and other game events via user-selectable advertising options, such as options provided by the various ad providers 304 of the 3rd part advertisement network 302. That is, the game server 300 may include a variety of methods for integrating conditionally sequenced advertising directly into game friction points, pinch points and/or “gates,” such as by determining user eligibility for an advertising offer and displaying the interactive promotional content offer alongside other existing options (e.g., “ask friends”, “buy energy/cash”). When the user selects the advertising option, they are not taken out of the flow of the game and instead the game server 300 may sequentially display a number of different content items and/or activities, responsive to user interaction therewith. Once completed, the game server 300 returns the user to the game with a live update/visual confirmation of the reward item, without requiring a refresh of the game, among other benefits.

As described herein, the game server 300 and/or the 3rd party advertisement server 302 may publish, present, and/or display a variety of different user interfaces to a user via the user client device 312.

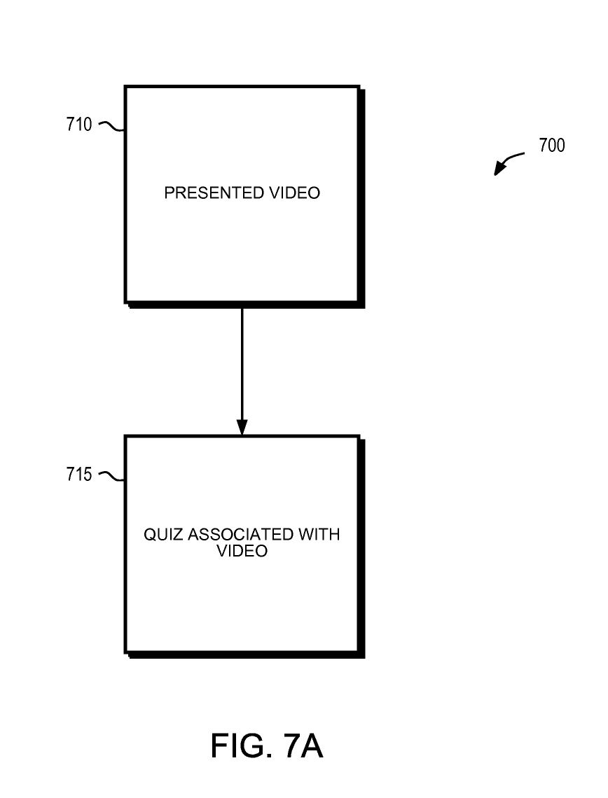

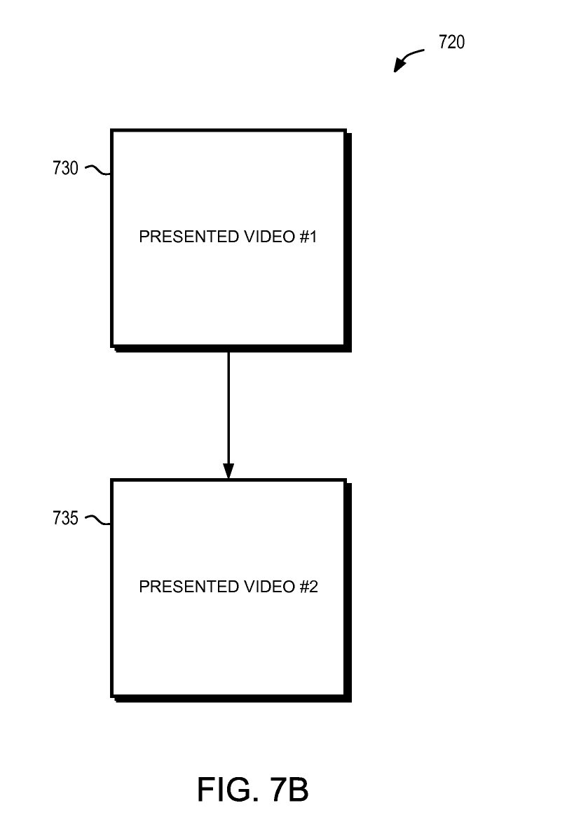

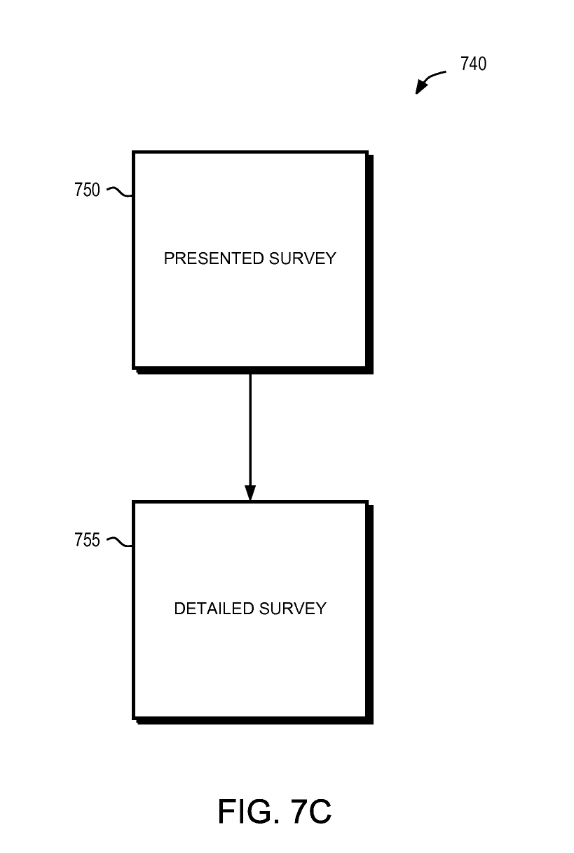

FIGS. 7A-7C are display sequence diagrams illustrating example displays of sequences of sponsored interactive content, in some example embodiments.

FIG. 7A depicts a sequence of sponsored content 700, in which user interface 710 presents a video or other visual content to a player, and user interface 715 presents a quiz associated with the video. Upon the player interacting with the sequence of sponsored content presented in the UIs, the systems described herein may utilize method 600 and provide the player with rewards as follows:

when the player watches the video 710, the system provides the player with enough currency to resolve a friction point within the game; and

when the player watches the video 710 and takes the quiz 715, the system provides the player with enough currency to resolve a friction point within the online game and an additional amount of bonus currency to be used within the online game. The video 710 and the quiz 715 may be presented one after the other in a single user interface (UI), or may be presented in separate parallel UIs.

FIG. 7B depicts a sequence of sponsored content 720, in a user interface presents a first video 730 or other visual content to a player, and another interface (or, in some embodiment, the same UI) presents a second video 735 or other visual content to a player. Upon the player interacting with the sequence of sponsored content, the systems described herein may utilize method 600 and provide the player with rewards as follows:

when the player watches the first video 730, the system provides a first tier of reward energy to the player; and

when the player watches the first video 730 and the second video 735, the system provides the first tier of reward energy and two additional tiers of reward energy.

FIG. 7C depicts a sequence of sponsored content 740, in which a user interface presents an interactive survey 750 to a player, and presents a detailed aspect 755 of the survey to the player. Upon the player interacting with the sequence of sponsored content 740, the systems described herein may utilize method 600 and provide the player with rewards as follows:

when the player takes the general survey 750, the system provides a first tier of reward energy to the player; and

when the player takes the detailed survey 755, the system provides the first tier of reward energy and additional tiers of energy based on the answers and/or comments provided by the player within the detailed survey.

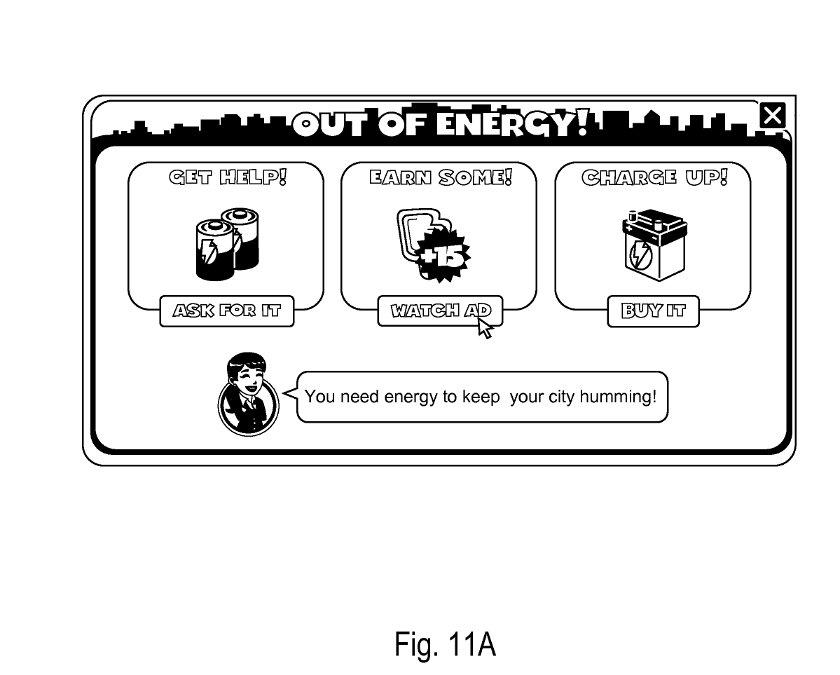

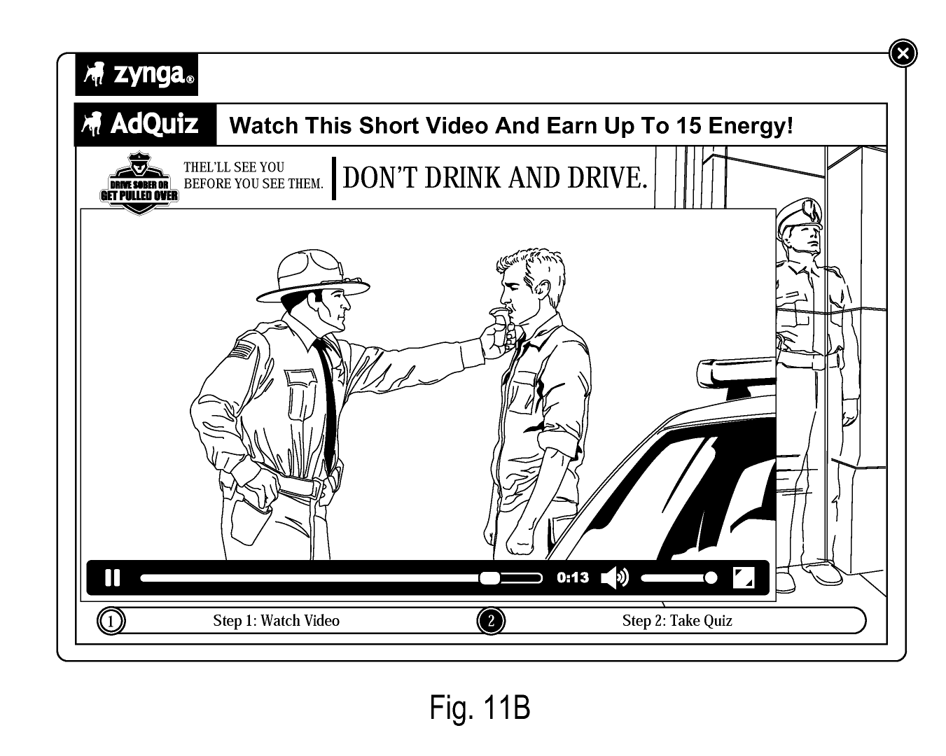

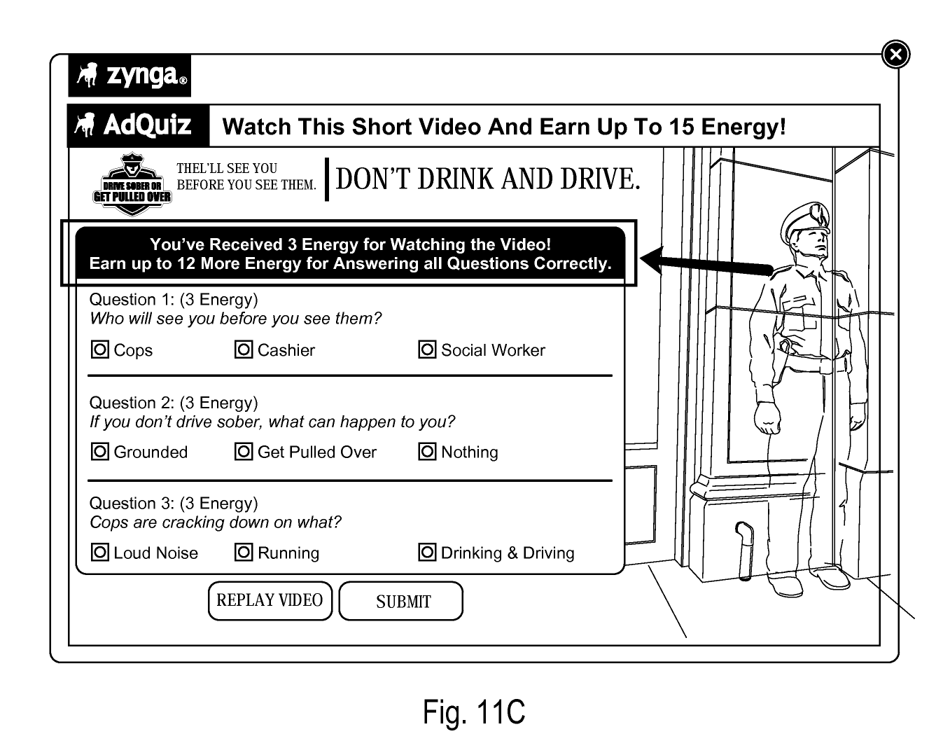

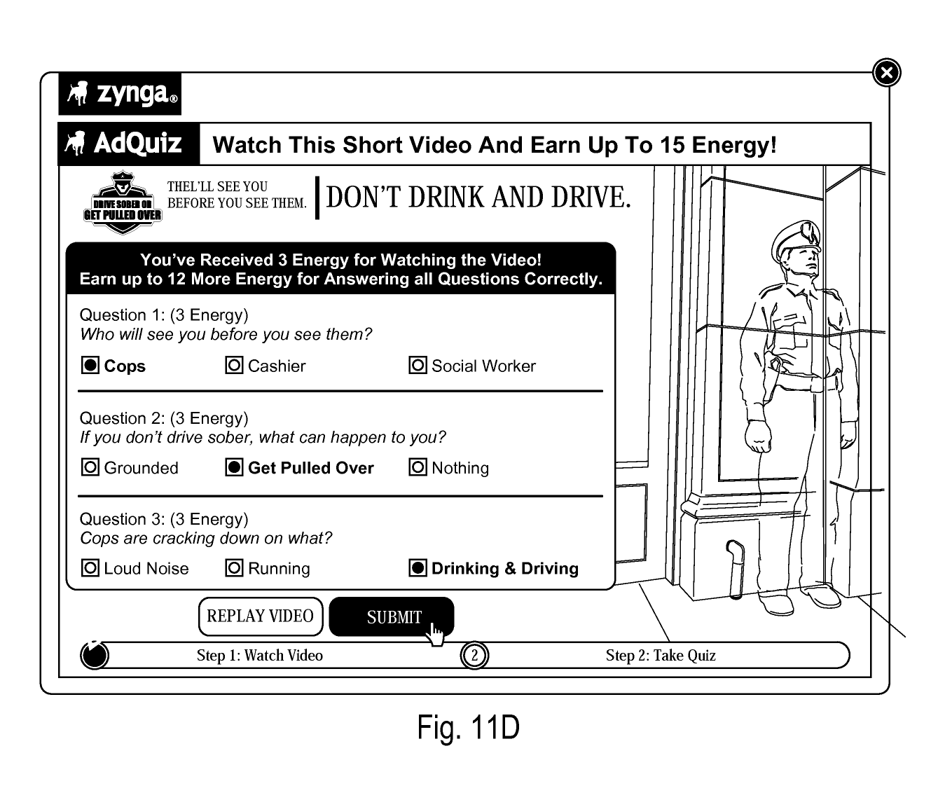

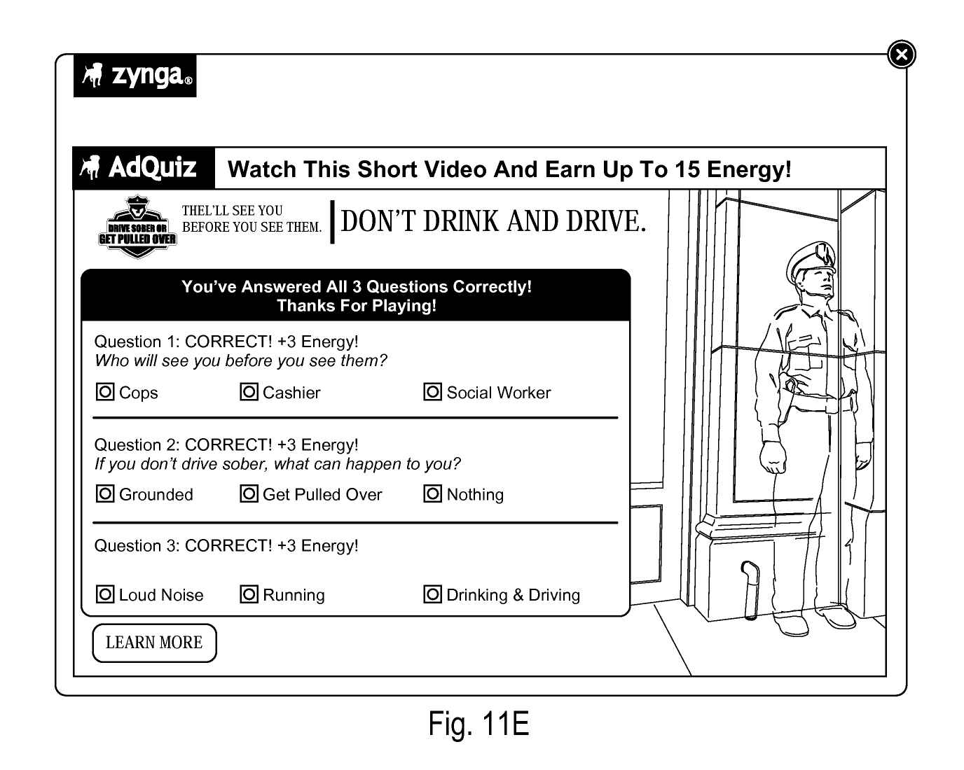

FIGS. 11A-F shows an example embodiment of a plurality of on-screen advertising content and associated user interfaces that are displayed to the user to prompt performance of a linked sequence of player interaction (also referred to elsewhere herein as sponsored activities) with the associated promotional material or advertising content.

Selection of the “Watch Ad” button in the prompt of FIG. 11A results in a first player interaction (a CPE activity) that involves watching a promotional video advertisement. Watching the add results in an in-game reward, as communicated in the automatically linked and sequentially displayed interface of FIG. 11C.

The UI of FIG. 11C is also a prompt and associated incentive offering for a successive engagement in the sequence, here comprising answering a survey related to the earlier displayed video content. The survey can be submitted via the interface, as shown in FIG. 11D, automatically resulting in the reward for the second CPE engagement. Note the survey reward is greater in value than the video reward.

In other examples, the systems and methods described herein may support some or all of the following use cases:

(a) Player comes across Idle Prompt or Branded HUD (Heads Up Display) icon and is given an opportunity to view a Watch To Earn (W2E) video ad. The player views first W2E video ad, and receives reward grant. Interface system 320 tracks that player has completed first part (video) of W2E video campaign, and player is prompted to view second W2E video ad for additional reward. Player views second W2E video ad, and receives associated reward grant.

(b) Player comes across Idle Prompt or Branded HUD icon and is given opportunity to take W2E survey. Player completes survey. Survey results are collected and stored in interface system 320 database. Player receives reward grant.

(c) Player comes across Idle Prompt or Branded HUD icon and is given opportunity to view W2E video ad. Player chooses to view W2E video ad. Player receives reward grant. Player is prompted to take quiz for additional reward. Player completes quiz. Quiz results are collected and stored. Player receives reward grant.

(d) Player comes across Idle Prompt or Branded HUD icon and is given opportunity to take (two-part) W2E survey. Player completes first part of survey. Player receives reward grant. Player is prompted to take second part of survey for additional reward. Player completes second part of survey. Survey results are collected and stored. Player receives reward grant.

(e) Player comes across Idle Prompt or Branded HUD icon and is given opportunity to view W2E video ad. Player chooses to view W2E video ad. Survey results are collected and stored. Player receives reward grant. Player is prompted to take Ad Quiz for additional reward. Player does not complete second part of survey. Player closes W2E Ad container. Player comes back to game later and comes across Idle Prompt or Branded HUD icon and is given opportunity to take W2E Ad Quiz. Player is also presented with opportunity to view W2E video ad again. Player completes ad quiz correctly. Player receives associated reward grant.

(f) Player comes across Idle Prompt or Branded HUD icon and is given opportunity to take two-part W2E survey. Player completes first part of survey. Survey results are collected and stored. Player receives reward. Player is prompted to take second part of W2E survey. Player does not complete second part of survey, and closes W2E Ad container. Player comes back to game later and comes across Idle Prompt or Branded HUD icon and is given opportunity to take W2E survey. Player completes second part of survey. Survey results are collected and stored. Player receives reward grant.

(g) Player comes across Idle Prompt or Branded HUD icon and is given opportunity to view W2E video ad. Player chooses to view W2E video ad. Survey results collected and stored. Player receives reward grant. Player is prompted to complete an action (purchase, sign-up) at an external web site for an additional reward. Player clicks link and a new window is open on that external web site. A secondary reward is granted to the player upon completion of the action on the external website.

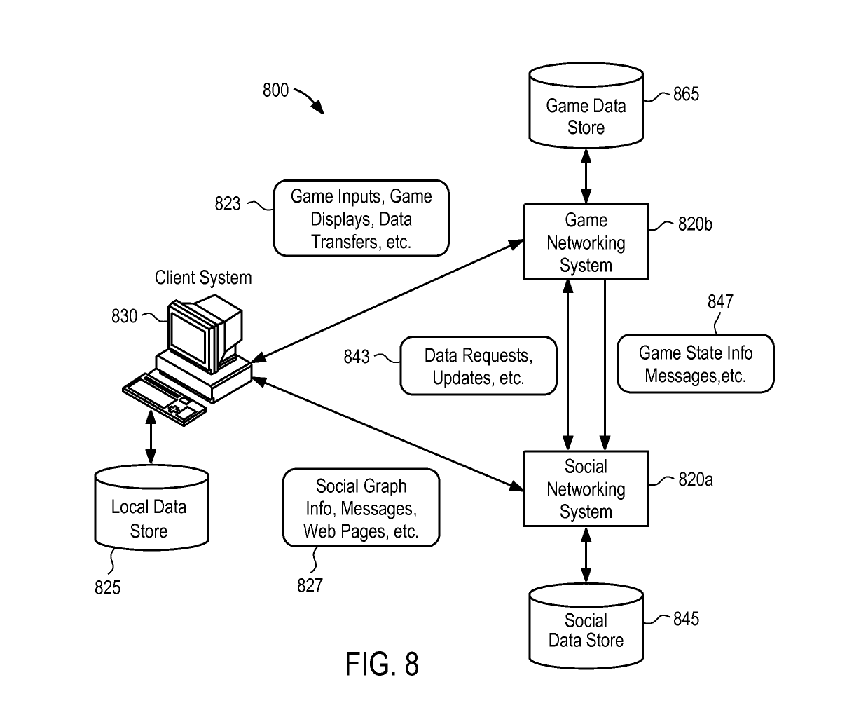

FIG. 8 illustrates an example data flow between the components of system 800. In particular embodiments, system 800 can include client system 830, social networking system 820a, and game networking system 820b. The components of system 800 can be connected to each other in any suitable configuration, using any suitable type of connection. The components may be connected directly or over any suitable network. Client system 830, social networking system 820a, and game networking system 820b can each have one or more corresponding data stores such as local data store 825, social data store 845, and game data store 865, respectively. Social networking system 820a and game networking system 820b can also have one or more servers that can communicate with client system 830 over an appropriate network. Social networking system 820a and game networking system 820b can have, for example, one or more internet servers for communicating with client system 830 via the Internet. Similarly, social networking system 820a and game networking system 820b can have one or more mobile servers for communicating with client system 830 via a mobile network (e.g., GSM, PCS, Wi-Fi, WPAN, and the like). In some embodiments, one server may be able to communicate with client system 830 over both the Internet and a mobile network. In other embodiments, separate servers can be used.

Client system 830 can receive and transmit data 823 to and from game networking system 820b. This data can include, for example, webpages, messages, game inputs, game displays, HTTP packets, data requests, transaction information, updates, and other suitable data. At some other time, or at the same time, game networking system 820b can communicate data 843, 847 (e.g., game state information, game system account information, page info, messages, data requests, updates, and so forth) with other networking systems, such as social networking system 820a (e.g., Facebook®, Myspace, and the like). Client system 830 can also receive and transmit data 827 to and from social networking system 820a. This data can include, for example, webpages, messages, social graph information, social network displays, HTTP packets, data requests, transaction information, updates, and other suitable data.

Communication between client system 830, social networking system 820a, and game networking system 820b can occur over any appropriate electronic communication medium or network using any suitable communications protocols. For example, client system 830, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as HTTP and other communications protocols, such as HTTP-S, FTP, SNMP, TELNET, and a number of other protocols. In addition, a server in one interaction context may be a client in another interaction context. In particular embodiments, the information transmitted between hosts may be formatted as HTML documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 820b, the BLOB containing the game state for the instance corresponding to the player can be transmitted to client system 830 for use by a client-side executed object to process. In particular embodiments, the client-side executable may be a FLASH-based game, which can de-serialize the game state data in the BLOB. As a player plays the game, the game logic implemented at client system 830 maintains and modifies the various game state parameters locally. The client-side game logic may also batch game events, such as mouse clicks, and transmit these events to game networking system 820b. Game networking system 820b may itself operate by retrieving a copy of the BLOB from a database or an intermediate memory cache (memcache) layer. Game networking system 820b can also de-serialize the BLOB to resolve the game state parameters and execute its own game logic based on the events in the batch file of events transmitted by the client to synchronize the game state on the server side. Game networking system 820b may then re-serialize the game state, now modified, into a BLOB and pass this to a memory cache layer for lazy updates to a persistent database.

With a client-server environment in which the online games may run, one server system, such as game networking system 820b, may support multiple client systems 830. At any given time, there may be multiple players at multiple client systems 830, all playing the same online game. In practice, the number of players playing the same game at the same time may be very large. As the game progresses with each player, multiple players may provide different inputs to the online game at their respective client systems 830, and multiple client systems 830 may transmit multiple player inputs and/or game events to game networking system 820b for further processing. In addition, multiple client systems 830 may transmit other types of application data to game networking system 820b.

In particular embodiments, a computer-implemented game may be a text-based or turn-based game implemented as a series of web pages that are generated after a player selects one or more actions to perform. The web pages may be displayed in a browser client executed on client system 830. As an example and not by way of limitation, a client application downloaded to client system 830 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF (Small Web Format) object that is embedded in a web page and executable by a Flash media player plug-in. In particular embodiments, one or more described webpages may be associated with or accessed by social networking system 820a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 830, either caused by an action of a game player or by the game logic itself, client system 830 may need to inform game networking system 820b of the update. For example, if the game is a farming game with a harvest mechanic (such as Zynga® FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 800 is discussed in reference to updating a multi-player online game hosted on a network-addressable system (such as, for example, social networking system 820a or game networking system 820b), where an instance of the online game is executed remotely on a client system 830, which then transmits application event data to the hosting system such that the remote game server synchronizes game state associated with the instance executed by the client system 830.

In particular embodiments, one or more objects of a game may be represented as an Adobe® Flash (or other authoring environment, such as HTML5) object. Flash may manipulate vector and raster graphics, and supports bidirectional streaming of audio and video. “Flash” may mean the authoring environment, the player, or the application files. In particular embodiments, client system 630 may include a Flash client. The Flash client may be configured to receive and run Flash application or game object code from any suitable networking system (such as, for example, social networking system 820a or game networking system 820b). In particular embodiments, the Flash client may be run in a browser client executed on client system 830. A player can interact with Flash objects using client system 830 and the Flash client. The Flash objects can represent a variety of in-game objects. Thus, the player may perform various in-game actions on various in-game objects by making various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 830, the Flash client may send the events that caused the game state changes to the in-game object to game networking system 820b. However, to expedite the processing and hence the speed of the overall gaming experience, the Flash client may collect a batch of some number of events or updates into a batch file. The number of events or updates may be determined by the Flash client dynamically or determined by game networking system 820b based on server loads or other factors. For example, client system 830 may send a batch file to game networking system 820b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 830. In particular embodiments, the batch file may be a text file and the name-value pairs may be in string format.

In particular embodiments, when a player plays an online game on client system 830, game networking system 820b may serialize all the game-related data, including, for example and without limitation, game states, game events, and user inputs, for this particular user and this particular game into a BLOB and store the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 820b may retrieve the corresponding BLOB from the database to determine the most-recent values of the game-related data. In particular embodiments, while a player is playing the online game, game networking system 820b may also load the corresponding BLOB into a memory cache so that the game system may have faster access to the BLOB and the game-related data contained therein.

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

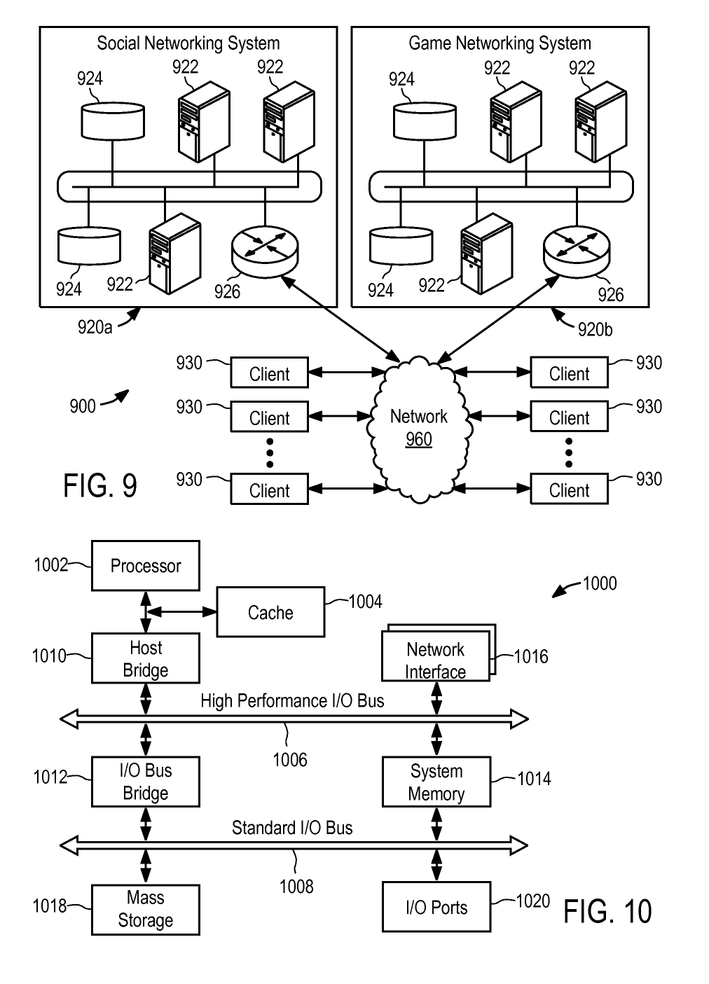

Particular embodiments may operate in a WAN environment, such as the Internet, including multiple network addressable systems. FIG. 9 illustrates an example network environment 900, in which various example embodiments may operate. Network cloud 960 generally represents one or more interconnected networks, over which the systems and hosts described herein can communicate. Network cloud 960 may include packet-based WANs (such as the Internet), private networks, wireless networks, satellite networks, cellular networks, paging networks, and the like. As FIG. 9 illustrates, particular embodiments may operate in a network environment comprising one or more networking systems, such as social networking system 920a, game networking system 920b, and one or more client systems 930. The components of social networking system 920a and game networking system 920b operate analogously; as such, hereinafter they may be referred to simply at networking system 920. Client systems 930 are operably connected to the network environment via a network service provider, a wireless carrier, or any other suitable means.

Networking system 920 is a network addressable system that, in various example embodiments, comprises one or more physical servers 922 and data stores 924. The one or more physical servers 922 are operably connected to network cloud 960 via, by way of example, a set of routers and/or networking switches 926. In an example embodiment, the functionality hosted by the one or more physical servers 922 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML, Extensible Markup Language (XML), Java, JavaScript, Asynchronous JavaScript and XML (AJAX), Flash, ActionScript, and the like.

Physical servers 922 may host functionality directed to the operations of networking system 920. Hereinafter servers 922 may be referred to as server 922, although server 922 may include numerous servers hosting, for example, networking system 920, as well as other content distribution servers, data stores, and databases. Data store 924 may store content and data relating to, and enabling, operation of networking system 920 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like. Logically, data store 924 corresponds to one or more of a variety of separate and integrated databases, such as relational databases and object-oriented databases, that maintain information as an integrated collection of logically related records or files stored on one or more physical systems. Structurally, data store 924 may generally include one or more of a large class of data storage and management systems. In particular embodiments, data store 924 may be implemented by any suitable physical system(s) including components, such as one or more database servers, mass storage media, media library systems, storage area networks, data storage clouds, and the like. In one example embodiment, data store 924 includes one or more servers, databases (e.g., MySQL), and/or data warehouses. Data store 924 may include data associated with different networking system 920 users and/or client systems 930.

Client system 930 is generally a computer or computing device including functionality for communicating (e.g., remotely) over a computer network. Client system 930 may be a desktop computer, laptop computer, personal digital assistant (PDA), in- or out-of-car navigation system, smart phone or other cellular or mobile phone, or mobile gaming device, among other suitable computing devices. Client system 930 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 930 to enter addresses of specific network resources to be retrieved, such as resources hosted by networking system 920. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is HTML. Other common web browser-supported languages and technologies include XML, the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 930 desires to view a particular webpage (hereinafter also referred to as a target structured document) hosted by networking system 920, the user's web browser, or other document rendering engine or suitable client application, formulates and transmits a request to networking system 920. The request generally includes a URL or other document identifier as well as metadata or other information. By way of example, the request may include information identifying the user, such as a user ID, as well as information identifying or characterizing the web browser or operating system running on the user's client computing device 930. The request may also include location information identifying a geographic location of the user's client system or a logical network location of the user's client system. The request may also include a timestamp identifying when the request was transmitted.

Although the example network environment described above and illustrated in FIG. 9 is described with respect to social networking system 920a and game networking system 920b, this disclosure encompasses any suitable network environment using any suitable systems. As an example and not by way of limitation, the network environment may include online media systems, online reviewing systems, online search engines, online advertising systems, or any combination of two or more such systems.

FIG. 10 illustrates an example computing system architecture, which may be used to implement a server 1222 or a client system 1230. In one embodiment, a hardware system 1000 comprises a processor 1002, a cache memory 1004, and one or more executable modules and drivers, stored on a tangible computer readable medium, directed to the functions described herein. Additionally, hardware system 1000 may include a high performance input/output (I/O) bus 1006 and a standard I/O bus 1008. A host bridge 1010 may couple processor 1002 to high performance I/O bus 1006, whereas I/O bus bridge 1012 couples the two buses 1006 and 1008 to each other. A system memory 1014 and one or more network/communication interfaces 1016 may couple to bus 1006. Hardware system 1000 may further include video memory (not shown) and a display device coupled to the video memory. Mass storage 1018 and I/O ports 1020 may couple to bus 1008. Hardware system 1000 may optionally include a keyboard, a pointing device, and a display device (not shown) coupled to bus 1008. Collectively, these elements are intended to represent a broad category of computer hardware systems, including but not limited to general purpose computer systems based on the x86-compatible processors manufactured by Intel Corporation of Santa Clara, California, and the x86-compatible processors manufactured by Advanced Micro Devices (AMD), Inc., of Sunnyvale, California, as well as any other suitable processor.

The elements of hardware system 1000 are described in greater detail below. In particular, network interface 1016 provides communication between hardware system 1000 and any of a wide range of networks, such as an Ethernet (e.g., IEEE 802.3) network, a backplane, and so forth. Mass storage 1018 provides permanent storage for the data and programming instructions to perform the above-described functions implemented in servers 1222, whereas system memory 1014 (e.g., DRAM) provides temporary storage for the data and programming instructions when executed by processor 1002. I/O ports 1020 are one or more serial and/or parallel communication ports that provide communication between additional peripheral devices, which may be coupled to hardware system 1000.

Hardware system 1000 may include a variety of system architectures, and various components of hardware system 1000 may be rearranged. For example, cache memory 1004 may be on-chip with processor 1002. Alternatively, cache memory 1004 and processor 1002 may be packed together as a “processor module,” with processor 1002 being referred to as the “processor core.” Furthermore, certain embodiments of the present disclosure may not require nor include all of the above components. For example, the peripheral devices shown coupled to standard I/O bus 1008 may couple to high performance I/O bus 1006. In addition, in some embodiments, only a single bus may exist, with the components of hardware system 1000 being coupled to the single bus. Furthermore, hardware system 1000 may include additional components, such as additional processors, storage devices, or memories.

An operating system manages and controls the operation of hardware system 1000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a,” “an,” or “the” is intended to mean “one or more” unless specifically indicated to the contrary. In addition, it is to be understood that functional operations, such as “awarding,” “locating,” “permitting,” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features, and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, and the like), that makes API calls directly to a server. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

1. A method comprising:
determining occurrence of a trigger event in a computer-implemented game played by a player on a user device;
in an automated operation performed by one or more processors in response to the trigger event, presenting on the user device interactive promotional content comprising a sequence of sponsored activities for performance by the player, at least one of the sequence of sponsored activities being a gated activity whose availability for performance by the player is conditional upon performance of a respective preceding sponsored activity in the sequence;
determining a level of interaction of the player with the interactive promotional content; and
providing a benefit to the player based at least in part on the determined level of interaction.

2. The method of claim 1, wherein presenting the sequence of sponsored activities comprises allowing the user to perform only a subset of the sequence, so that a quantity of sponsored activities performed by the player is player-selectable.

3. The method of claim 2, wherein the determining of the level of interaction of the player with the interactive promotional material comprises determining the quantity of sponsored activities in the sequence performed by the player.

4. The method of claim 3, wherein the determining of the level of interaction is based at least in part on a respective performance score achieved by the player in at least one of the sequence of sponsored activities.

5. The method of claim 1, wherein the trigger event comprises a friction point within a game fiction.

6. The method of claim 5, further comprising presenting to the user, in response to detecting the friction point, a plurality of alternative options for resolving the friction point in the game fiction, the plurality of alternative options including an activity sequence option associated with the interactive promotional content, wherein the presenting of the interactive promotional content is in response to user-selection of the activity sequence option.

7. The method of claim 1, wherein the presenting of the interactive promotional content comprises presenting the sequence of sponsored activities as a linked series that is substantially uninterrupted by gameplay between neighboring activities in the sequence.

8. The method of claim 1, wherein the promotional content is with respect to a common brand and/or product, each sponsored activity in the sequence having content pertaining to the common brand and/or product.

9. The method of claim 1, wherein the sequence of sponsored activities comprises a plurality of different types of activities.

10. The method of claim 1, wherein presenting the sequence of sponsored activities comprises presenting a plurality of activities having sponsored content including one or more of:
an advertisement, video content, a survey related to a brand or product, and an interactive mini-game.

11. The method of claim 1, wherein the sequence of sponsored activities includes:
a video activity in which video content related a brand or product is displayed on the user device; and
an interactive survey about the video content, the interactive survey being presented subsequent to the video activity.

12. The method of claim 1, wherein each sponsored activity in the sequence has a corresponding reward for completion thereof, and wherein the rewards progressively increase in value with an increase in progression along the sequence.

13. A system comprising:
a presentation trigger module configured to determine occurrence of a trigger event in a computer-implemented game played by a player on a user device;
a content presentation module configured to present, using one or more computer processors, interactive promotional content on the user device in response to occurrence of the trigger event, the interactive promotional content comprising a sequence of sponsored activities for performance by the player, at least one of the sequence of sponsored activities being a gated activity whose availability for performance by the player is conditional upon performance of a respective preceding sponsored activity in the sequence;
a content interaction module configured to determine a level of interaction of the player with the interactive promotional content; and
a benefit module configured to provide a benefit to the player based at least in part on a level of interaction of the player with the interactive promotional content.

14. The system of claim 13, wherein the content interaction module is configured to allow the user to perform a user-selected subset of the sequence of sponsored activities.

15. The system of claim 14, wherein the content interaction module is configured to determine the level of interaction by a process comprises quantifying the sponsored activities in the user-selected subset of sponsored activities.

16. The system of claim 13, wherein the determining of the level of interaction is based at least in part on respective performance scores achieved by the player in one or more of the sequence of sponsored activities.

17. The system of claim 1, wherein the trigger event comprises a friction point within a game fiction of the game played on the user device, the system further comprising a game fiction module configured launch the trigger event in the game fiction.

18. The system of claim 17, wherein the game fiction module is configured to present on the user device, in response to detecting the friction point, a plurality of alternative options for resolving the friction point in the game fiction, the plurality of alternative options including an activity sequence option associated with the interactive promotional content.

19. The system of claim 13, wherein the content presentation module is configured to present the sequence of sponsored activities as a linked series that is substantially uninterrupted by gameplay between neighboring activities in the sequence.

20. The system of claim 13, wherein the sequence of sponsored activities comprises a plurality of different types of activities.

21. The system of claim 13, wherein the content presentation module is configured such that the sequence of sponsored activities include sponsored content including one or more of: an advertisement, video content, a survey, and a minigame.

22. The system of claim 13, wherein the sequence of sponsored activities includes:
a video activity in which video content related a brand or product is displayed on the user device; and
an interactive survey about the video content, the interactive survey being presented subsequent to the video activity.

23. The system of claim 13, wherein each sponsored activity in the sequence has a corresponding reward for completion thereof, and wherein the rewards progressively increase in value with an increase in progression along the sequence.

24. A non-transitory computer-readable storage medium including instructions, when executed by a computer, to cause the computer to perform operations comprising:
determining occurrence of a trigger event in a computer-implemented game played by a player on a user device;
in response to the trigger event, presenting on the user device interactive promotional content comprising a sequence of sponsored activities for performance by the player, at least one of the sequence of sponsored activities being a gated activity whose availability for performance by the player is conditional upon performance of a respective preceding sponsored activity in the sequence;
determining a level of interaction of the player with the interactive promotional content; and
providing a benefit to the player based at least in part on the determined level of interaction.
